(19) United States
(12) Patent Application Publication
(10) Pub. No.: US 2026/0048990 A1
(43) Pub. Date: Feb. 19, 2026

(54) METHODS FOR SYNTHESIZING MXENES VIA SUPERCRITICAL FLUID PROCESS

(71) Applicant: Ballydel Technologies, Inc., Wilmington, DE (US)

(72) Inventors: Brendan DeLacy, Bel Air, MD (US); Ryan Ferguson, Holmdel, NJ (US); Adam Goad, Greenville, DE (US); Jack Googasian, Wilmington, DE (US)

(21) Appl. No.: 19/303,296

(22) Filed: Aug. 18, 2025

Related U.S. Application Data
(60) Provisional application No. 63/684,330, filed on Aug. 16, 2024.

(51) Int. Cl. C01B 32/90

(52) U.S. Cl. CPC C01B 32/90; C01P 2002/72; C01P 2004/03; C01P 2004/20

(57) ABSTRACT

A method for synthesizing two-dimensional MXenes from MAX phase materials is disclosed, utilizing a supercritical fluid process. The method involves preparing a liquid medium containing a MAX phase material and one or more halogenating agents, sealing the liquid medium within a supercritical vessel, and etching the MAX phase material by introducing a fluid and adjusting the vessel's interior conditions to achieve a supercritical state. This process allows for the conversion of MAX phase materials into MXenes without generating hydrofluoric acid (HF) in situ.

### PRIORITY

This patent application is related to and claims the priority benefit of U.S. Provisional Patent Application No. 63/684,330 filed Aug. 16, 2024. The content of the foregoing application is hereby incorporated by reference in its entirety into this disclosure.

### GOVERNMENT SUPPORT

This invention was made with government support under Grant No. FA2394-23-C-B022 awarded by the US Air Force (Phase II STTR). The government may have certain rights in the invention.

### TECHNICAL FIELD

The present disclosure relates to the field of materials science and engineering, specifically to the synthesis of two-dimensional (2D) materials known as MXenes. The methods pertain to the conversion of MAX phase materials into MXenes using a supercritical fluid process, which involves the use of halogenating agents in a supercritical fluid environment.

### BACKGROUND

MXenes are a family of two-dimensional (2D) layered transitional metal carbides, nitrides, and carbonitrides, characterized by properties such as high electrical conductivity and catalytic behavior. MXenes are typically synthesized via a top-down approach, wherein parent materials known as Mₙ₊₁AXₙ (or MAX) phases are transformed into MXenes. MAX phases are composed of successive atomic layers of transition metals (M) and can include elements from groups 13-15 of the periodic table (A), carbon and/or nitrogen (X). The A layers can be selectively removed through acid etching, resulting in the separation of MX layers to form MXenes. Ti₃C₂Tₓ is a commonly studied MXene within this category.

MXenes are conventionally made by etching MAX phases to remove the A layers using hydrofluoric acid (HF) with or without hydrochloric acid (HCl).

Supercritical carbon dioxide (CO₂) synthesis has been employed by Chen et al. to convert MAX phases into MXenes using ammonium bifluoride (NH₄F₂) as an etchant, as detailed in Chen et al., Supercritical etching method for the large-scale manufacturing of MXenes, Nano Energy 107: 108147 (2023). In this method, ammonium bifluoride was dissolved in propylene carbonate, an aprotic polar solvent. However, the solubility of ammonium bifluoride in propylene carbonate is limited, which constrains the concentration of fluorine anions in the supercritical fluid atmosphere, thereby reducing etching efficiency.

To address this, water has been explored as an alternative solvent for dissolving ammonium bifluoride in the supercritical environment. This approach can enhance the solubility of ammonium bifluoride; however, it also results in the formation of hydrofluoric acid (HF) in-situ. HF is an undesirable, toxic acid that is highly corrosive that not only etches the MAX phase but can also corrode the steel vessel used in the reaction.

Therefore, there is a need for an improved process for manufacturing MXenes that enhances etching efficiency while minimizing corrosive by-products.

### SUMMARY

The present disclosure provides a method for synthesizing two-dimensional (2D) MXenes from MAX phase materials using a supercritical fluid process. The method can comprise preparing a liquid medium comprising a MAX phase material and one or more halogenating agents, sealing the solution within a supercritical vessel, and etching the MAX phase material by introducing a fluid and adjusting the vessel's interior conditions to achieve a supercritical state. The process allows for the conversion of MAX phase materials into MXenes without generating hydrofluoric acid (HF) in situ, offering a safer and more efficient alternative to traditional etching methods. The resulting MXene compositions can be suitable for various applications, including battery technologies and coatings. The method is adaptable to different MAX phase materials and can accommodate various batch sizes, providing flexibility in production scale.

In certain embodiments, a method for synthesizing 2D MXenes can comprise preparing a liquid medium comprising a MAX phase material and one or more halogenating agents; sealing the liquid medium within an interior of a supercritical vessel, wherein the vessel is configured to withstand elevated pressures and temperatures necessary for achieving supercritical conditions within the interior; and etching the MAX phase material within the liquid medium to convert the MAX phase material to MXenes by introducing a fluid into an interior of the sealed vessel and adjusting the interior conditions of the supercritical vessel to convert the fluid to a supercritical state. Preparing the liquid medium can comprise combining the MAX phase material and the one or more halogenating agents and melting the one or more halogenating agents. Preparing the liquid medium can comprise dissolving (or otherwise mixing) the one or more halogenating agents in a solvent to form a liquid medium and adding the MAX phase material to the liquid medium.

The interior conditions of the sealed vessel can comprise temperature and/or pressure. The pressure can be at or approximately 800 psi to at or approximately 5000 psi (or 4000 psi) and/or the temperature can be at or approximately 30° C. to at or approximately 130° C. or 375° C. In certain embodiments, the pressure can range from approximately 1071 psi to approximately 4000 psi, and can optionally be approximately 1500 psi.

Preparing the liquid medium can comprise dissolving the one or more halogenating agents in a solvent and adding the MAX phase material to the liquid medium. The solvent can be water. In certain embodiments, the one or more halogenating agents are dissolved in water. The solvent can be a polar solvent. The solvent can be a polar aprotic solvent. The polar solvent can comprise at least one of water, methanol, or ethanol. The polar aprotic solvent can be or comprise at least one of acetone, dimethylformamide (DMF), acetonitrile, dimethyl sulfoxide, or propylene carbonate.

In certain embodiments, the method further comprises venting the vessel to adjust the internal pressure within the supercritical vessel to match ambient atmospheric pressure and/or washing the MXenes to remove residual reactants.

At least one of the halogenating agents can be a fluorinating agent. In certain embodiments, one or more halogenating agents includes one or more halogen salts, each independently containing fluorine (F), chlorine (Cl), bromine (Br), iodine (I), astatine (At), or tennessine (Ts). In certain embodiments, the one or more halogenating agents are tetramethylammonium fluoride (TMAF), TMAF tetrahydrate (TMAF·4H₂O), ammonium fluoride (NH₄F), potassium fluoride (KF), and/or derivatives of any of the foregoing. In certain embodiments the one or more halogenating agents are hydrated salts. In certain embodiments, the fluorinating agent is not HF.

The MAX phase material can be a layered ternary carbide or nitride characterized by the general formula Mₙ₊₁AXₙ, wherein M is a transition metal, A is an A-group element, and X is carbon (C) and/or nitrogen (N). The MAX phase material can be or comprise Ti₃AlC₂, Ti₃SiC₂, Ti₂AlC, or Cr₂AlC.

The fluid can be or comprise carbon dioxide (CO₂), nitrogen (N₂) (such as N₂ gas), nitrous oxide (N₂O), water (H2O), or any other suitable fluid that can achieve a supercritical state. Where the fluid is or comprises CO₂, the pressure can be at or approximately 1071 psi and the temperature being at or approximately 31° C.; or where the fluid as N₂, the pressure can be at or approximately 493 psi and the temperature being at or approximately −147° C.; or where the fluid is H2O, the pressure can be at or approximately 3203 psi and the temperature can be at or approximately 374° C.

The etching step can be performed for a duration ranging from approximately 1 hour to approximately 24 hours. The etching step can be performed for a duration of approximately 5 hours.

The method can (optionally) further comprise delaminating the MXenes. The delamination of the MXenes can be executed through one or more of sonication, high shear mixing, homogenization, chemical intercalation, manual shaking, planetary mixing, or milling, for example. In certain embodiments, the delamination of the MXenes is executed using a Taylor Vortex Flow Reactor.

The method can be performed using a supercritical vessel. The supercritical vessel can comprise (or be formed of) a nickel-molybdenum alloy which optionally is a Hastelloy alloy. The nickel-molybdenum alloy can be selected from the group consisting of Hastelloy C and Hastelloy B. Optionally, the nickel-molybdenum alloy can be Hastelloy C-276. The supercritical vessel can be a nickel-based alloy, the alloy comprising nickel, chromium, molybdenum, iron, carbon, silicon, and optionally tungsten.

In certain embodiments, a method for synthesizing MXenes is provided that comprises: combining MAX phase material and one or more halogenating agents and melting the one or more halogenating agents to form a liquid medium, or dissolving the one or more halogenating agents in a solvent and adding a MAX phase material to form a liquid medium; sealing the liquid medium within an interior of a supercritical vessel, wherein the vessel is configured to withstand elevated pressures and temperatures necessary for achieving supercritical conditions within the interior; introducing fluid into, and adjusting a temperature and pressure within, the interior of the vessel to convert the fluid to a supercritical state, etch the MAX phase material in the liquid medium, and convert the MAX phase material into MXenes; venting the interior of the supercritical vessel to ambient pressure; and washing the MXenes to remove residual reactants. The one or more halogenating agents can be NH₄F and dissolving the one or more halogenating agents in a solvent can be performed with approximately 13 g of NH₄F in about 40 mL of water. The one or more halogenating agents can be TMAF·4H₂O and approximately 29.2 g of TMAF·4H₂O can be combined with the MAX phase material and melted.

In certain embodiments, the supercritical vessel is equipped with a rupture disc, a thermocouple, an inlet valve, an outlet valve, a pressure gauge, and an overhead stirrer. The pressure within the vessel can be adjusted within a range extending from ambient atmospheric pressure up to at least approximately 3000 psi, approximately 4000 psi, or approximately 5000 psi (or at least approximately 5000 psi). The temperature within the vessel can be adjusted within a range extending from ambient temperature to approximately 131° C. (at least).

The etching step can range from approximately 1 hour to approximately 24 hours. In certain embodiments, the method can further comprise converting multilayered MXenes to a delaminated form using ultrasonic probe, mechanical agitation, or intercalation. The intercalation can be performed using lithium chloride (LiCl), for example. In certain embodiments, HF is not produced during etching.

In certain embodiments, performing the methods hereof results in a MXene batch size of at or between approximately 1 gram to at or approximately 10 grams, at or approximately 50 grams, at or approximately 0.5 kg, or more than approximately 0.5 kg.

### BRIEF DESCRIPTION OF THE DRAWINGS

The accompanying drawings, which are incorporated in and constitute a part of this specification, illustrate various embodiments and, together with the description, serve to explain the principles of the disclosed subject matter. It should be understood that the drawings are provided for purposes of illustration and are not intended to limit the scope of the claims in any manner.

FIG. 1 illustrates a schematic representation of the MXene structure and its formation process derived from MAX phase materials, detailing the layered arrangement and etching process involved.

FIG. 2 depicts a representative schematic of a supercritical fluid reaction setup, which can be utilized in executing the methods described herein, including components such as the reaction chamber, pressure control system, and temperature regulation apparatus.

FIG. 3 is a scanning electron microscope (SEM) image depicting a multilayered MXene structure synthesized utilizing the methods described herein.

FIG. 4 depicts an X-ray diffraction (XRD) spectrum, providing a comparative analysis between Ti₃AlC₂ MAX phase materials and a multilayered MXene structure, Ti₃C₂Tₓ (wherein x is surface termination groups), synthesized using the methods described in the present disclosure.

### DETAILED DESCRIPTION

The present disclosure pertains to a method for synthesizing two-dimensional (2D) MXenes from MAX phase materials utilizing a supercritical fluid process.

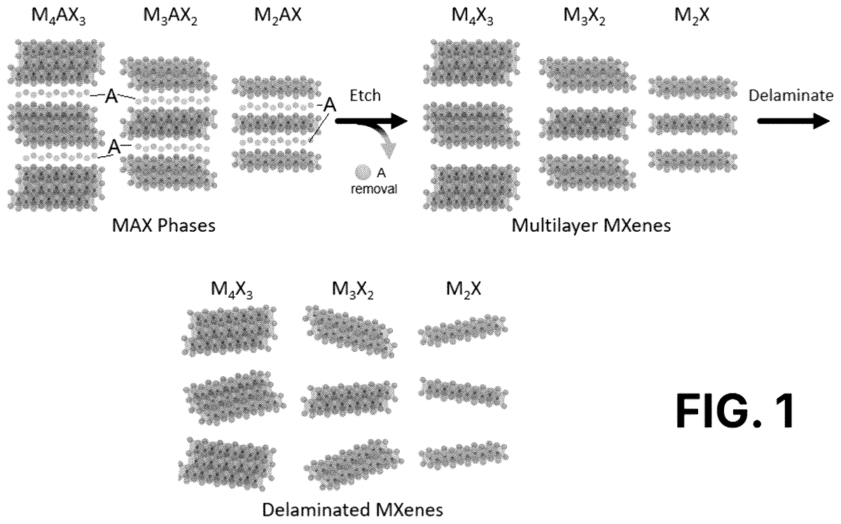

MXenes represent a family of 2D layered transition metal carbides, nitrides, and carbonitrides, which exhibit characteristics such as high electrical conductivity and catalytic behavior. FIG. 1 provides a schematic representation of various MXene structures and the corresponding MAX phase parent material. As used herein, the terms “MXene,” “MXene compositions,” or “MXene materials” refer to compositions comprising either single or multilayer, substantially 2D crystalline solids. Generally, these materials are recognized in the art, for example, as described in U.S. Pat. No. 9,193,595. MXenes can be present as individual layers, stacked layers, or stacked assemblies. These compositions can exist in various forms, including in suspension, as a deposited coating, incorporated into another material, or as free-standing structures. MXenes can be distinguished by their unique structural configuration, which can contribute to their utility in various applications, such as energy storage, catalysis, or electronic devices.

Analogous to other 2D, atomically-scaled materials, such as graphene or hexagonal boron nitride (BN), these 2D transition metal carbides, nitrides, and/or carbonitrides can exist as flakes, individual layers or be incorporated into stacked compositions. As utilized herein, individual layers comprise adjacent composite crystal layers that are not bonded to one another through covalent bonds or metal-lattice bonds, while stacked compositions are individual layers that are joined by interlayer hydrogen bonds or weaker interactions. Flakes, individual layers, and/or stacked configurations can be deposited onto substrates or embedded within polymer matrices or other materials, such as glass.

As noted above, MXenes can comprise crystalline compositions comprising at least one layer having first and second surfaces, each layer comprising a high aspect ratio 2D array of crystal unit cells, which are unique characteristics of these materials. For purposes of visualization, the two-dimensional array of crystal unit cells can be viewed as an array of unit cells extending in an x-y plane, with the z-axis defining the thickness of the composition, without any restrictions as to the absolute orientation of that plane or axes. At least one layer having first and second surfaces can contain a single 2D array of crystal unit cells (that is, the z-dimension is defined by the dimension of approximately one crystal unit cell), such that the planar surfaces of said cell array define the surface of the layer. However, compositions can contain portions having more than single crystal unit cell thicknesses. Further, the surface(s) of each MXene can be functionalized with various surface termination groups, such as hydroxyl (—OH), oxygen (O), and/or halides (e.g., —F, —Cl, —Br, —I, —At, —Ts). This functionalization can enhance the diversity of these materials.

MXenes can also comprise disordered or partially ordered layers, including but not limited to solid-solution MXenes, mixed-metal or mixed-anion MXenes, defect-rich MXenes, or other non-stoichiometric MXene structures. The term “MXene” as used herein encompasses any structural configuration, degree of ordering, or compositional variation of MXenes that is recognized in the art, including configurations that deviate from the idealized layered structure. Such variations include, for example, MXenes with layer stacking faults, surface terminations, intercalants, vacancies, or substitutional disorder. All known and future-developed MXene configurations and compositions are encompassed within this disclosure.

Halogen salts, such as fluoride salts, exhibit high solubility in water and other protic solvents. It was observed that their application in synthesizing MXenes mitigates the production of hydrofluoric acid (HF) in situ. The disclosed methods facilitate the presence of an excess of fluorine or other halogen anions in the liquid medium, which are available for etching the MAX phase material. For instance, in the presence of water, ammonium fluoride dissociates into NH₄⁺ and F⁻ ions, and HF is not generated. This can be particularly advantageous as HF—whether used as a reagent or generated in situ—is an extremely toxic and corrosive acid and poses hazard risks that require the use of specialized protective equipment.

Additionally, it was observed that a neutral pH is maintained even when the concentration of ammonium fluoride in the solvent is varied. Moreover, the disclosed methods enable a reduction in the overall time required to convert MAX phase materials into multilayered MXene as compared to conventional HF etching methods.

In certain embodiments, a method for synthesizing 2D MXenes can comprise the following steps: preparing a liquid medium (e.g., an aqueous solution or a molten salt) that includes a MAX phase material and one or more halogenating agents; sealing the liquid medium within a supercritical vessel; and etching the MAX phase materials within the liquid medium to convert the MAX phase materials to MXenes. This conversion can be achieved by introducing a fluid into the vessel and adjusting the interior conditions, such as temperature and pressure, to transition the fluid into a supercritical state. The supercritical state of the etchant can facilitate the etching process by enhancing the penetration and reactivity of the etchant with the MAX phase materials. Each of these steps, along with potential variations, are described in detail below.

For preparing the liquid medium, the MAX phase material can be any MAX phase material known in the art. MAX phase materials are a family of layered ternary carbides and/or nitrides characterized by the general formula Mₙ₊₁AXₙ, where M represents a transition metal, A denotes an A-group element (such as elements from groups 13-15 of the periodic table), and X is carbon (C) and/or nitrogen (N) (refer to FIG. 1). The transition metal (M) in the MAX phase material can include, without limitation, titanium (Ti), vanadium (V), niobium (Nb), tantalum (Ta), chromium (Cr), or molybdenum (Mo). The A-group element (A) of the MAX phase materials can comprise boron (B), aluminum (Al), gallium (Ga), indium (In), thallium (Tl), nihonium (Nh), carbon, silicon (Si), germanium (Ge), tin (Sn), lead (Pb), flerovium (Fl), nitrogen, phosphorus (P), arsenic (As), antimony (Sb), bismuth (Bi), and/or moscovium (Mc). The MAX phase materials can be any listed in Table 1 (examples of synthesized single metal MAX phase materials), Table 2 (examples of synthesized i-MAX phase materials), and Table 3 (examples of synthesized o-MAX phase materials). The MAX phase materials can be any described in Alam et al., Synthesis, characterizations and challenges, Engineering Reports 6(8): e12911 (2024).

TABLE 1

| | | | |
|---|---|---|---|
| Al | Ti₂AlC, V₂AlC, Cr₂AlC, Zr₂AlC, Nb₂AlC, | Si | Ti₃SiC₂, Ti₄SiC₃, Ti₅Si₂C₃, Ti₇Si₂C₅ |
| | Hf₂AlC, Ta₂AlC, Ti₂AlN, Ti₃AlC₂, Zr₃AlC₂, | | |
| | Ta₃AlC₂, Hf₃AlC₂, V₄AlC₃, Nb₄AlC₃, Ta₄AlC₃, | | |
| | Ti₄AlN₃, Ta₆AlC₅, Ti₅Al₂C₃ | | |
| P | V₂PC, Nb₂PC | S | Ti₂SC, Zr₂SC, Nb₂SC, Hf₂SC, |
| | | | Zr₂SB, Nb₂SB, Hf₂SB |
| Fe | Ta₂FeC, Nb₂FeC, Ti₂FeN | Co | Nb₂CoC, Ta₂CoC |
| Ni | Nb₂NiC, Ta₂NiC | Cu | Nb₂CuC, Ti₄CuN₃ |
| Zn | Ti₂ZnC, V₂ZnC, Ti₃ZnC₂, Nb₂ZnC, Ti₂ZnN | Ga | Ti₂GaC, V₂GaC, Cr₂GaC, Mn₂GaC, |
| | | | Nb₂GaC, Mo₂GaC, Ta₂GaC, |
| | | | Ti₂GaN, V₂GaN, Cr₂GaN, Ti₃GaC₂, |
| | | | Ti₄CaC₃, Mo₂Ga₂C |
| Ge | Ti₂GelC, V₂GeC, Cr₂GeC, Zr₂GeC, Zr₂GeC, | As | V₂AsC, Nb₂AsC |
| | Ti₃GeC₂, Ti₄GeC₃, Ti₅Ge₂C₅ | | |
| Se | Zr₂SeC, Hf₂SeC, Zr₂SeB, Hf₂SeB | | |
| Cd | Ti₂CdC, Ti₃Cd₂C₂ | In | Ti₂InC, Zr₂InC, Hf₂InC, Nb₂InC, |
| | | | Ti₂InN, Zr₂InN, Ti₃InC₂, Zr₃InC₂, |
| | | | Hf₃InC₂, Hf₂InN |
| Sn | Sc₂SnC, Ti₂SnC, V₂SnC, Zr₂SnC, Nb₂SnC, | Sb | Ti₂SbP, Zr₂SbP, Hf₂SbP, Nb₂SbC, |
| | Hf₂SnC, Lu2SnC, Hf₂SnN, Nb₂SnB, Ti₃SnC₂, | | Ti₃SbC₂ |
| | Zr₃SnC₂, Hf₃SnC₂, Ti₇SnC₆ | | |
| Te | Hf₂TeB | | |
| Ir | Ti₃IrC₂ | Pt | Nb₂PtC |
| Au | Ti₃AuC₂, Ti₃Au₂C₂, Ti₂Au₂C, Mo₂AuC, | Ti | Ti₂TlC, Zr₂TlC, Hf₂TlC, Zr₂TlN |
| | Nb₂AuC, Cr₂AuC, Ti₂AuN | | |
| Pb | Sc₂PbC, Ti₂PbC, Zr₂PbC, Hf₂PbC, Zr₃PbC₂, | Bi | Nb₂Bi₂C |
| | Hf₃PbC₂ | | |

TABLE 2
i-MAX
(Mo_{2/3}Sm_{1/3})₂AlC, (Mo_{2/3}Nd_{1/3})₂AlC,
(Mo_{2/3}Gd_{1/3})₂AlC, (Mo_{2/3}Tb_{1/3})₂AlC, (Mo_{2/3}Ho_{1/3})₂AlC, (Mo_{2/3}Dy_{1/3})₂AlC, (Mo_{2/3}Er_{1/3})₂AlC,
(Mo_{2/3}Tm_{1/3})₂AlC, (Mo_{2/3}Gd_{1/3})₂GaC, (Mo_{2/3}Lu_{1/3})₂AlC, (Mo_{2/3}Tb_{1/3})₂GaC, (Mo_{2/3}Tb_{1/3})₂GaC,
(Mo_{2/3}Dy_{1/3})₂GaC, (Mo_{2/3}Er_{1/3})₂GaC, (Mo_{2/3}Ho_{1/3})₂GaC, (Mo_{2/3}Tm_{1/3})₂GaC,
(Mo_{2/3}Lu_{1/3})₂GaC, (Mo_{2/3}Yb_{1/3})₂GaC, W_{4/3}Y_{2/3}AlC, W_{4/3}Gd_{2/3}AlC, W_{4/3}Tb_{2/3}AlC, W_{4/3}Dy_{2/3}AlC,
W_{4/3}Ho_{2/3}AlC, W_{4/3}Er_{2/3}AlC, (Mn_{2/3}Sc_{1/3})₂GaC, (Cr_{2/3}Sc_{1/3})₂GaC, (Mo_{2/3}Ce_{1/3})₂AlC,
(Mo_{2/3}Pr_{1/3})₂AlC, Mo_{4/3}Sc_{2/3}AlC, Mo_{4/3}Y_{2/3}AlC, W_{4/3}Tm_{2/3}AlC, W_{4/3}Lu_{2/3}AlC, Cr_{4/3}Sc_{2/3}GaC,
W_{4/3}Dy_{2/3}AlC, W_{4/3}Ho_{2/3}AlC, W_{4/3}Er_{2/3}AlC,
(Mn_{2/3}Sc_{1/3})₂GaC, (Cr_{2/3}Sc_{1/3})₂GaC, (Mo_{2/3}Ce_{1/3})₂AlC, (Mo_{2/3}Pr_{1/3})₂AlC, Mo_{4/3}Sc_{2/3}AlC,
V_{4/3}Sc_{2/3}AlC, V_{4/3}Z_{12/3}AlC, Cr_{4/3}Sc_{2/3}AlC, Cr_{4/3}Y_{2/3}AlC, Cr_{4/3}Zr_{2/3}AlC, (W_{2/3}Sc_{1/3})₂AlC,
(Mo_{2/3}Y_{1/3})₂AlC, (V_{2/3}Zr_{1/3})₂AlC, (W_{2/3}Y_{1/3})₂AlC, (Cr_{2/3}Sc_{1/3})₂AlC, (Mo_{2/3}Y_{1/3})₂GaC,
(Mo_{2/3}Sc_{1/3})₂GaC, Cr_{4/3}Gd_{2/3}AlC,
Cr_{4/3}Tb_{2/3}AlC, Cr_{4/3}Dy_{2/3}AlC, Cr_{4/3}Ho_{2/3}AlC, Cr_{4/3}Er_{2/3}AlC, Cr_{4/3}Tm_{2/3}AlC, Cr_{4/3}Lu_{2/3}AlC,
W_{4/3}Sc_{2/3}AlC, Mn_{4/3}Sc_{2/3}GaC, Mo_{4/3}Sc_{2/3}GaC,
Mo_{2/3}Y_{1/3}GaC, Mo_{4/3}Gd_{2/3}GaC, Mo_{4/3}Tb_{2/3}GaC, Mo_{4/3}Dy_{2/3}GaC, Mo_{4/3}Ho_{2/3}GaC, Mo_{4/3}Er_{2/3}GaC,
Mo_{4/3}Tm_{2/3}GaC, Mo_{4/3}Yb_{2/3}GaC, Mo_{4/3}Lu_{2/3}GaC, (W_{0.5}Mo_{0.5})_{4/3}Y_{2/3}AlC,
W_{2/3}Mo_{2/3}Gd_{2/3}AlC, (W_{0.5}Mo_{0.5})_{4/3}Tb_{2/3}AlC, (W0.5Mo0.5)_{4/3}Dy_{2/3}AlC, (W0.5Mo0.5)_{4/3}Ho_{2/3}AlC,
(W_{0.5}Mo_{0.5})_{4/3}Er_{2/3}AlC,
Mo₂(Ga_{0.1}Au_{0.9})₂C, Nb₂(Al_{0.2}Au_{0.8})C, Mo₂(Ga_{0.1}Au_{0.9})₂C, Ti₃(Al_{1/3}Cu_{2/3})C₂, (Mo_{2/3}Sc_{1/3})₂Alc,
(Cr_{2/3}Y_{1/3})₂AlC, (Cr_{2/3}Zr_{1/3})AlC₂, Mo_{4/3}Ce_{2/3}AlC, Mo_{4/3}Tm_{2/3}AlC, Mo_{4/3}Eu_{2/3}AlC

TABLE 3
o-MAX
(Cr_{2/3}V_{1/3})₃AlC, (Cr_{2/3}Ti_{1/3})₃AlC, (Mo₂Ti)AlC₂,
Cr₂TiAlC₂, (Cr_{0.75}V_{0.25})₂VAlC₂, (Mo₂Sc)AlC₂, (Cr₂V₂)AlC₃, (Mo₂Ti₂)AlC₃, Cr₂₊ₓTi₂₋ₓAlC₃
(x = 0.5), (Cr_{0.7}V_{0.3})₂(Cr_{0.2}V_{0.8})₂AlC₃, Mo₂Nb₂AlC₃

The A layers can be removed through etching, resulting in the formation of MXenes. Furthermore, the resultant individual layers can be separated from one another.

In certain embodiments, the MAX phase material is Ti₃SiC₂, Ti₂AlC, or Cr₂AlC. In certain embodiments, the MAX phase material is Ti₃AlC₂. In certain embodiments, the MAX phase material is Ti₂SC, Zr₂SC, Ti₃SiC₂, Ti₃GeC₂, or Ti₄AlN₃.

The liquid medium comprises both MAX phase materials and one or more halogenating agents. The halogenating agents can include one or more halogen salts, which are compounds formed by the reaction of halogens with metals. The halogen salt can contain, for example, elements selected from the group consisting of fluorine, chlorine (Cl), bromine (Br), iodine (I), astatine (At), or tennessine (Ts). The halogen salts can be in the form of compounds such as sodium fluoride (NaF), potassium chloride (KCl), calcium bromide (CaBr₂), or lithium iodide (LiI), among others. These halogen salts can facilitate the halogenation process by providing halogen ions in the liquid medium. In certain embodiments, the halogenating agents of the method do not include hydrofluoric acid (HF). The halogenating agent can be a fluorinating agent. A fluorinating agent is a chemical compound or substance that facilitates the introduction of fluorine atoms into a target molecule through a chemical reaction. Fluorinating agents can vary in their reactivity and selectivity and can include elemental fluorine or fluorine-containing compounds, or salts or hydrates of either of the foregoing.

In certain embodiments, the fluorinating agents can be ammonium fluoride (NH₄F), tetramethylammonium fluoride (TMAF), potassium fluoride (KF), or derivatives thereof. In certain embodiments, the halogenating agents comprise one or more fluorinating agents, with the proviso that the fluorinating agents are not HF.

In certain embodiments, the halogenating agents can exist in unsolvated forms as well as solvated forms, including hydrated forms. The term “solvate” means a halogenating agent (e.g., a salt) that further includes a stoichiometric or non-stoichiometric amount of solvent bound by non-covalent intermolecular forces. Where the solvent is water, the solvate is a hydrate. For example, and without limitation, where the halogenating agent comprises TMAF, TMAF can be provided in a solvated form, tetramethylammonium fluoride tetrahydrate (TMAF·4H₂O). In certain embodiments, the liquid medium comprises a hydrated salt and/or a melted/molten form of any of the hydrated salts described herein.

In certain embodiments, the fluorinating agent is TMAF, which has been observed to exhibit enhanced etching efficiency relative to other fluorinating agents. In certain embodiments, the fluorinating agent is NH₄F or KF (or a derivative thereof), which have also demonstrated efficient etching capabilities. Regarding corrosion, both NH₄F and TMAF may corrode stainless-steel vessels under specific conditions.

The liquid medium can be an aqueous solution. In certain embodiments, the liquid medium comprises the melt of a hydrated salt, as distinguished from an aqueous solution thereof. For example, and without limitation, the liquid medium can comprise the melt of TMAF·4H₂O. As used herein, the term “hydrated salt melt” refers to the molten liquid phase obtained by heating a crystalline salt that contains water of hydration, such that the water of hydration is retained in association with the salt in the molten state. A hydrated salt melt is thus distinct from an aqueous solution of the salt (in which the salt is dissolved in free liquid water) and encompasses molten phases of salts such as NH₄F H₂O, KF·2H₂O, or similar hydrates.

The liquid medium can comprise a solvent. In certain embodiments, the preparation of the liquid medium further comprises dissolving one or more halogenating agents in a solvent, followed by the addition of the MAX phase material(s). In certain embodiments, the preparation of the liquid medium comprises melting a hydrated salt of one or more halogenating agents, followed by the addition of the MAX phase material(s).

The solvent can be selected based on the solubility of the fluid. The solvent can be a polar solvent. In some embodiments, the polar solvent is a polar aprotic solvent such as, for example, acetone, dimethylformamide (DMF), acetonitrile, dimethyl sulfoxide, or propylene carbonate. In some embodiments, the polar solvent comprises at least one of the following: water, methanol, ethanol, dimethyl sulfoxide, or acetonitrile.

Any appropriate quantity of halogenating agents, solvent, and MAX phase materials can be utilized in formulating the liquid medium. The specific amounts can be adjusted to provide a concentration of halogen anions, such as fluoride anions, relative to the A elements of the MAX phase materials, sufficient to facilitate the formation of A-halogen compound during the etching process. For example, and without limitation, in certain embodiments, the quantity of halogenating agents, solvent, and MAX phase materials are each independently selected to ensure a minimum of 3 halogen atoms for each one A element of the MAX phase materials (a 3:1 ratio).

In certain embodiments, the ratio of halogen atoms of halogenating agent to atoms of A element of the MAX phase materials is approximately 2:1 to approximately 20:1. In certain embodiments, the ratio of halogen atoms of halogenating agent to atoms of A element of the MAX phase materials is approximately 3:1. In certain embodiments, the ratio of halogen atoms of halogenating agent to atoms of A element of the MAX phase materials is approximately 4:1. In certain embodiments, the ratio of halogen atoms of halogenating agent to atoms of A element of the MAX phase materials is approximately 5:1. In certain embodiments, the ratio of halogen atoms of halogenating agent to atoms of A element of the MAX phase materials is approximately 6:1. In certain embodiments, the ratio of halogen atoms of halogenating agent to atoms of A element of the MAX phase materials is approximately 7:1. In certain embodiments, the ratio of halogen atoms of halogenating agent to atoms of A element of the MAX phase materials is approximately 8:1. In certain embodiments, the ratio of halogen atoms of halogenating agent to atoms of A element of the MAX phase materials is approximately 9:1. In certain embodiments, the ratio of halogen atoms of halogenating agent to atoms of A element of the MAX phase materials is approximately 10:1. In certain embodiments, the ratio of halogen atoms of halogenating agent to atoms of A element of the MAX phase materials is approximately 11:1. In certain embodiments, the ratio of halogen atoms of halogenating agent to atoms of A element of the MAX phase materials is approximately 12:1. In certain embodiments, the ratio of halogen atoms of halogenating agent to atoms of A element of the MAX phase materials is approximately 13:1. In certain embodiments, the ratio of halogen atoms of halogenating agent to atoms of A element of the MAX phase materials is approximately 14:1. In certain embodiments, the ratio of halogen atoms of halogenating agent to atoms of A element of the MAX phase materials is approximately 15:1. In certain embodiments, the ratio of halogen atoms of halogenating agent to atoms of A element of the MAX phase materials is approximately 16:1. In certain embodiments, the ratio of halogen atoms of halogenating agent to atoms of A element of the MAX phase materials is approximately 17:1. In certain embodiments, the ratio of halogen atoms of halogenating agent to atoms of A element of the MAX phase materials is approximately 18:1. In certain embodiments, the ratio of halogen atoms of halogenating agent to atoms of A element of the MAX phase materials is approximately 19:1. In certain embodiments, the ratio of halogen atoms of halogenating agent to atoms of A element of the MAX phase materials is approximately 20:1. In certain embodiments, the ratio can exceed 20:1. It has been observed that an increase in the ratio can correlate with an enhancement in etching efficiency.

In certain embodiments, the liquid medium comprises approximately 10 to 60 grams of halogenating agents in approximately 10 to 100 mL of solvent. It will be appreciated that any volume of solvent can be used, or no solvent can be used, provided a sufficient number of halogenating agents are present as described above. Practically, the volume of solvent employed can be based on the interior volume of the vessel chamber 7 (described below). Where the one or more halogenating agents are in hydrated salt form, solvent may not be required as, when melted, the hydrated salts can result in a molten salt.

The liquid medium can comprise halogenating agents in an amount of approximately 10 grams, approximately 10.5 grams, approximately 11 grams, approximately 11.5 grams, approximately 12 grams, approximately 12.5 grams, approximately 13 grams, approximately 13.5 grams, approximately 14 grams, approximately 14.5 grams, approximately 15 grams, approximately 15.5 grams, approximately 16 grams, approximately 16.5 grams, approximately 17 grams, approximately 17.5 grams, approximately 18 grams, approximately 18.5 grams, approximately 19 grams, approximately 19.5 grams, approximately 20 grams, approximately 20.5 grams, approximately 21 grams, approximately 21.5 grams, approximately 22 grams, approximately 22.5 grams, approximately 23 grams, approximately 23.5 grams, approximately 24 grams, approximately 24.5 grams, approximately 25 grams, approximately 25.5 grams, approximately 26 grams, approximately 26.5 grams, approximately 27 grams, approximately 27.5 grams, approximately 28 grams, approximately 28.5 grams, approximately 29 grams, approximately 29.5 grams, approximately 30 grams, approximately 30.5 grams, approximately 31 grams, approximately 31.5 grams, approximately 32 grams, approximately 32.5 grams, approximately 33 grams, approximately 33.5 grams, approximately 34 grams, approximately 34.5 grams, approximately 35 grams, approximately 35.5 grams, approximately 36 grams, approximately 36.5 grams, approximately 37 grams, approximately 37.5 grams, approximately 38 grams, approximately 38.5 grams, approximately 39 grams, approximately 39.5 grams, approximately 40 grams, approximately 40.5 grams, approximately 41 grams, approximately 41.5 grams, approximately 42 grams, approximately 42.5 grams, approximately 43 grams, approximately 43.5 grams, approximately 44 grams, approximately 44.5 grams, approximately 45 grams, approximately 45.5 grams, approximately 46 grams, approximately 46.5 grams, approximately 47 grams, approximately 47.5 grams, approximately 48 grams, approximately 48.5 grams, approximately 49 grams, approximately 49.5 grams, approximately 50 grams, approximately 50.5 grams, approximately 51 grams, approximately 51.5 grams, approximately 52 grams, approximately 52.5 grams, approximately 53 grams, approximately 53.5 grams, approximately 54 grams, approximately 54.5 grams, approximately 55 grams, approximately 55.5 grams, approximately 56 grams, approximately 56.5 grams, approximately 57 grams, approximately 57.5 grams, approximately 58 grams, approximately 58.5 grams, approximately 59 grams, approximately 59.5 grams, or approximately 60 grams. In certain embodiments, the liquid medium comprises approximately 29.2 grams of halogenating agents.

The liquid medium may or may not comprise an additional solvent. Where the liquid medium utilizes a hydrate of a halogen salt (or a derivative thereof), the salt can melt to molten form within the vessel and, thus, an additional solvent need not be required.

Alternatively, the liquid medium can further comprise an additional solvent. In certain embodiments, the liquid medium comprises a solvent in the amount of approximately 10 mL, 11 mL, 12 mL, 13 mL, 14 mL, 15 mL, 16 mL, 17 mL, 18 mL, 19 mL, 20 mL, 21 mL, 22 mL, 23 mL, 24 mL, 25 mL, 26 mL, 27 mL, 28 mL, 29 mL, 30 mL, 31 mL, 32 mL, 33 mL, 34 mL, 35 mL, 36 mL, 37 mL, 38 mL, 39 mL, 40 mL, 41 mL, 42 mL, 43 mL, 44 mL, 45 mL, 46 mL, 47 mL, 48 mL, 49 mL, 50 mL, 51 mL, 52 mL, 53 mL, 54 mL, 55 mL, 56 mL, 57 mL, 58 mL, 59 mL, 60 mL, 61 mL, 62 mL, 63 mL, 64 mL, 65 mL, 66 mL, 67 mL, 68 mL, 69 mL, 70 mL, 71 mL, 72 mL, 73 mL, 74 mL, 75 mL, 76 mL, 77 mL, 78 mL, 79 mL, 80 mL, 81 mL, 82 mL, 83 mL, 84 mL, 85 mL, 86 mL, 87 mL, 88 mL, 89 mL, 90 mL, 91 mL, 92 mL, 93 mL, 94 mL, 95 mL, 96 mL, 97 mL, 98 mL, 99 mL, or 100 mL.

In certain embodiments, the ratio of grams of halogenating agent to milliliters of solvent is approximately a 2:5 to approximately a 4:5 ratio. In certain embodiments, the ratio of grams of halogenating agent to milliliters of solvent is approximately 1:2. In certain embodiments, the ratio of grams of halogenating agent to milliliters of solvent is approximately 2:5. In certain embodiments, the ratio of grams of halogenating agent to milliliters of solvent is approximately 3:5. In certain embodiments, the ratio of grams of halogenating agent to milliliters of solvent is approximately 4:5.

The liquid medium can, for example, comprise approximately 12 grams of halogenating agents and approximately 20 mL of solvent. In certain embodiments, the liquid medium can, for example, comprise approximately 13 grams of halogenating agents and approximately 40 mL of solvent. In certain embodiments, the liquid medium comprises 12 grams of NH₄ in about 20 mL of water. In certain embodiments, the liquid medium comprises 13 grams of NH₄ in about 40 mL of water. In certain embodiments, the liquid medium comprises the following variations of halogenating agents and solvent amounts: approximately 6 grams of halogenating agent and approximately 10 mL of solvent; approximately 7.2 grams of halogenating agent and approximately 12 mL of solvent; approximately 8.4 grams of halogenating agent and approximately 14 mL of solvent; approximately 9.6 grams of halogenating agent and approximately 16 mL of solvent; approximately 10.8 grams of halogenating agent and approximately 18 mL of solvent; approximately 12 grams of halogenating agent and approximately 20 mL of solvent; approximately 13.2 grams of halogenating agent and approximately 22 mL of solvent; approximately 14.4 grams of halogenating agent and approximately 24 mL of solvent; approximately 15.6 grams of halogenating agent and approximately 26 mL of solvent; approximately 16.8 grams of halogenating agent and approximately 28 mL of solvent; approximately 18 grams of halogenating agent and approximately 30 mL of solvent; approximately 19.2 grams of halogenating agent and approximately 32 mL of solvent; approximately 20.4 grams of halogenating agent and approximately 34 mL of solvent; approximately 21.6 grams of halogenating agent and approximately 36 mL of solvent; approximately 22.8 grams of halogenating agent and approximately 38 mL of solvent; approximately 24 grams of halogenating agent and approximately 40 mL of solvent; approximately 25.2 grams of halogenating agent and approximately 42 mL of solvent; approximately 26.4 grams of halogenating agent and approximately 44 mL of solvent; approximately 27.6 grams of halogenating agent and approximately 46 mL of solvent; approximately 28.8 grams of halogenating agent and approximately 48 mL of solvent; approximately 30 grams of halogenating agent and approximately 50 mL of solvent; approximately 31.2 grams of halogenating agent and approximately 52 mL of solvent; approximately 32.4 grams of halogenating agent and approximately 54 mL of solvent; approximately 33.6 grams of halogenating agent and approximately 56 mL of solvent; approximately 34.8 grams of halogenating agent and approximately 58 mL of solvent; approximately 36 grams of halogenating agent and approximately 60 mL of solvent; approximately 37.2 grams of halogenating agent and approximately 62 mL of solvent; approximately 38.4 grams of halogenating agent and approximately 64 mL of solvent; approximately 39.6 grams of halogenating agent and approximately 66 mL of solvent; approximately 40.8 grams of halogenating agent and approximately 68 mL of solvent; approximately 42 grams of halogenating agent and approximately 70 mL of solvent; approximately 43.2 grams of halogenating agent and approximately 72 mL of solvent; approximately 44.4 grams of halogenating agent and approximately 74 mL of solvent; approximately 45.6 grams of halogenating agent and approximately 76 mL of solvent; approximately 46.8 grams of halogenating agent and approximately 78 mL of solvent; approximately 48 grams of halogenating agent and approximately 80 mL of solvent; approximately 49.2 grams of halogenating agent and approximately 82 mL of solvent; approximately 50.4 grams of halogenating agent and approximately 84 mL of solvent; approximately 51.6 grams of halogenating agent and approximately 86 mL of solvent; approximately 52.8 grams of halogenating agent and approximately 88 mL of solvent; approximately 54 grams of halogenating agent and approximately 90 mL of solvent; approximately 55.2 grams of halogenating agent and approximately 92 mL of solvent; approximately 56.4 grams of halogenating agent and approximately 94 mL of solvent; approximately 57.6 grams of halogenating agent and approximately 96 mL of solvent; approximately 58.8 grams of halogenating agent and approximately 98 mL of solvent; and approximately 60 grams of halogenating agent and approximately 100 mL of solvent.

In certain embodiments, the liquid medium comprises approximately 13 grams of halogenating agents and approximately 40 mL of solvent. The liquid medium can comprise approximately 14.3 grams of halogenating agents and approximately 44 mL of solvent; approximately 15.6 grams of halogenating agents and approximately 48 mL of solvent; approximately 16.9 grams of halogenating agents and approximately 52 mL of solvent; approximately 18.2 grams of halogenating agents and approximately 56 mL of solvent; approximately 19.5 grams of halogenating agents and approximately 60 mL of solvent; approximately 20.8 grams of halogenating agents and approximately 64 mL of solvent; approximately 22.1 grams of halogenating agents and approximately 68 mL of solvent; approximately 23.4 grams of halogenating agents and approximately 72 mL of solvent; approximately 24.7 grams of halogenating agents and approximately 76 mL of solvent; approximately 26 grams of halogenating agents and approximately 80 mL of solvent; approximately 27.3 grams of halogenating agents and approximately 84 mL of solvent; approximately 28.6 grams of halogenating agents and approximately 88 mL of solvent; approximately 29.9 grams of halogenating agents and approximately 92 mL of solvent; approximately 31.2 grams of halogenating agents and approximately 96 mL of solvent; approximately 32.5 grams of halogenating agents and approximately 100 mL of solvent.

Following preparation of the liquid medium (e.g., comprising the MAX phase materials, solvent, and one or more halogenating agents, or the MAX phase materials and the one or more halogenating agents in hydrated salt form for melting), the liquid medium is sealed within an interior of a supercritical vessel configured to withstand the elevated pressures and temperatures required for achieving supercritical conditions, and a fluid is introduced.

The supercritical vessel can be any sealable vessel known in the art, including but not limited to those designed to withstand high pressures and temperatures associated with supercritical fluid conditions. For example, the supercritical vessel can be configured to withstand up to or at least approximately 4000 psi within an interior chamber thereof. Such vessels typically comprise materials capable of maintaining structural integrity under these conditions, such as stainless steel or other high-strength alloys.

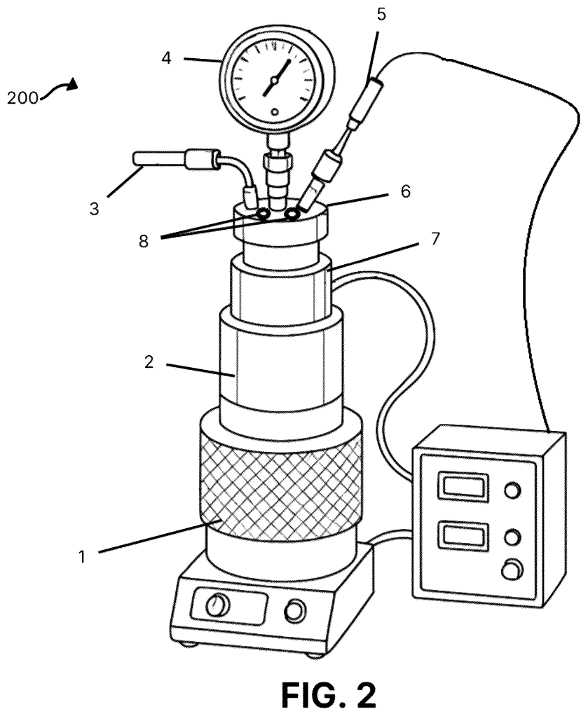

FIG. 2 illustrates a schematic of an exemplary supercritical vessel 200 that can be utilized to perform the method hereof. The supercritical vessel 200 comprises features such as pressure relief valves, temperature control systems, and insulation to ensure safe and efficient operation. In certain embodiments, the supercritical vessel 200 comprises a heating mantle 1, a heating jacket 2, an etching fluid inlet 3, a pressure gauge 4, a thermocouple 5, a vessel head 6, a vessel chamber 7 that defines a sealable an interior, and (optionally) an overhead stirrer to facilitate the etching process.

The vessel head 6 of the supercritical vessel 200 can comprise one or more ports 8 in fluid communication with the interior of the vessel chamber 7. Such ports 8 can comprise, for example, an inlet valve (not shown), an outlet valve (not shown), the pressure gauge 4, an overhead stirrer, and a rupture disc.

The rupture disc can function as a safety mechanism in scenarios where there is an unintended increase in pressure or temperature within the interior of the vessel chamber 7. The rupture disc can be configured, for example, to burst at a predetermined pressure threshold, which can be set below the maximum pressure rating of the vessel 200. Consequently, the rupture disc can be designed to activate prior to reaching the vessel's pressure rating, thereby mitigating the risk of structural failure.

At least the vessel chamber 7 of the supercritical vessel 200 can be composed of materials such as stainless steel or a corrosion-resistant alloy. The use of a supercritical vessel 200 formed of a corrosion-resistant alloy can mitigate the risk of corrosion and/or etching of the vessel chamber 7 by cations released during the etching process. Corrosion-resistant alloys, when utilized in the construction of the vessel chamber 7, can form a protective barrier that mitigates the interaction between the vessel chamber 7 and the etching agents. This barrier can serve to inhibit the degradation of the structural integrity of the chamber, in contrast to chambers formed solely of stainless steel.

In certain embodiments, at least the vessel chamber 7 of the vessel 200 comprises a nickel-based alloy, the alloy comprising nickel, chromium, molybdenum, iron, carbon, silicon, and optionally tungsten. In certain embodiments, the vessel chamber 7 comprises a nickel-molybdenum alloy, such as a Hastelloy alloy. In certain embodiments, the nickel-molybdenum alloy is selected from the group consisting of Hastelloy C and Hastelloy B. In certain embodiments, the vessel 200 comprises Hastelloy C-276.

The interior of the vessel chamber 7 is configured to receive the liquid medium. During operation, the pressure and temperature within the vessel chamber 7 are manipulated to achieve supercritical conditions for the fluid introduced through the etching fluid inlet 3. In certain embodiments, the temperature within the supercritical vessel 200 can be adjusted within a range extending from ambient temperature to approximately 125° C. or higher. This temperature adjustment can be facilitated by vessel 200 components such as the heating mantle 1 and the heating jacket 2, which provide controlled thermal input to the vessel chamber 7.

In certain embodiments, the pressure within the supercritical vessel 200 can be adjusted within a range extending from ambient atmospheric pressure up to approximately 3000 psi. This pressure adjustment can be facilitated by the pressure gauge 4, which provides real-time pressure readings, and the vessel head 6, which allows for precise control of the pressure within the vessel chamber 7. The pressure gauge 4 enables continuous monitoring of pressure levels, allowing for precise adjustments to maintain the desired pressure range.

It is understood that the interior conditions of the vessel chamber 7 (including, without limitation, both the temperature and pressure thereof) can be varied as required to optimize etching conditions. The ability to adjust these parameters allows for the fine-tuning of the etching process to achieve desired outcomes.

Referring back to the method steps, the process of etching MAX phase materials within the liquid medium to convert them to MXenes is facilitated by introducing a fluid into the interior of the vessel chamber 7 and adjusting the interior conditions of the vessel chamber 7 to convert the fluid to a supercritical state.

Supercritical fluids are characterized by low liquid interfacial tension and high gas diffusion coefficients, which contribute to their permeability and dissolution properties. This allows for the penetration of the fluid into small areas within a given micro-/nanometer sized structure. When employed in converting MAX phase materials into MXenes, this low surface tension can promote etchant to penetrate into the interstitial layers of the MAX phase materials, as the A element (e.g., aluminum) is etched away. Additionally, the pressure of the supercritical fluid can enhance the penetration of the etchant into the interstitial spaces of the MAX phase material, potentially improving the etching efficiency compared to conventional methods that do not utilize supercritical fluids.

The fluid can be introduced into the interior of the sealed vessel chamber 7 via the etching fluid inlet 3 using a high-pressure pump or other known means. The fluid can comprise carbon dioxide (CO₂), nitrogen (N₂), water (H₂O), methanol (CH₃OH), ethanol (C₂H₅OH), ammonia (NH₃), acetone, benzene, toluene, or other compositions that are suitable for supercritical applications. In certain embodiments, the fluid is CO₂. In certain embodiments, the fluid is nitrous oxide, N₂, or ammonia.

Once the fluid is added, the interior conditions of the vessel chamber 7 are adjusted to convert the fluid to a supercritical state. The supercritical state is achieved by controlling the interior conditions of the vessel chamber 7, such as temperature and pressure, by (for example) utilizing the heating mantle 1 and heating jacket 2 to regulate temperature, and the pressure gauge 4 to monitor pressure. In a supercritical vessel, the pressure within the vessel chamber 7 can be generated by the behavior of the fluid at elevated temperatures within a sealed environment, rather than being directly introduced through external means. This is achieved as the fluid reaches a supercritical state, where distinct liquid and gas phases do not exist, allowing for unique fluid properties. It should be noted that alternative vessel designs can be employed, such as those where pressure is directly adjusted via external mechanisms, provided that the vessel is capable of establishing conditions conducive to the liquid etchant achieving a supercritical state. Such conditions can be monitored and controlled using components like the pressure gauge 4 and thermocouple 5 as described above, to ensure the appropriate temperature and pressure levels are maintained.

In certain embodiments, the pressure within the interior of the vessel chamber 7 can be adjusted to between approximately 400 psi and approximately 4000 psi, or optionally up to at or approximately 5000 psi. In certain embodiments, the pressure is varied between at or approximately 1200 psi to at or approximately 2700 psi. The pressure can be adjusted to between approximately 450 psi and approximately 4950 psi, approximately 500 psi and approximately 4900 psi, approximately 550 psi and approximately 4850 psi, approximately 600 psi and approximately 4800 psi, approximately 650 psi and approximately 4750 psi, approximately 700 psi and approximately 4700 psi, approximately 750 psi and approximately 4650 psi, approximately 800 psi and approximately 4600 psi, approximately 850 psi and approximately 4550 psi, approximately 900 psi and approximately 4500 psi, approximately 950 psi and approximately 4450 psi, approximately 1000 psi and approximately 4400 psi, approximately 1050 psi and approximately 4350 psi, approximately 1100 psi and approximately 4300 psi, approximately 1150 psi and approximately 4250 psi, approximately 1200 psi and approximately 4200 psi, approximately 1250 psi and approximately 4150 psi, approximately 1300 psi and approximately 4100 psi, approximately 1350 psi and approximately 4050 psi, approximately 1400 psi and approximately 4000 psi, approximately 1450 psi and approximately 3950 psi, approximately 1500 psi and approximately 3900 psi, approximately 1550 psi and approximately 3850 psi, approximately 1600 psi and approximately 3800 psi, approximately 1650 psi and approximately 3750 psi, approximately 1700 psi and approximately 3700 psi, approximately 1750 psi and approximately 3650 psi, approximately 1800 psi and approximately 3600 psi, approximately 1850 psi and approximately 3550 psi, approximately 1900 psi and approximately 3500 psi, approximately 1950 psi and approximately 3450 psi, approximately 2000 psi and approximately 3400 psi, approximately 2050 psi and approximately 3350 psi, approximately 2100 psi and approximately 3300 psi, approximately 2150 psi and approximately 3250 psi, approximately 2200 psi and approximately 3200 psi, approximately 2250 psi and approximately 3150 psi, approximately 2300 psi and approximately 3100 psi, approximately 2350 psi and approximately 3050 psi, approximately 2400 psi and approximately 3000 psi, approximately 2450 psi and approximately 2950 psi, approximately 2500 psi and approximately 2900 psi, approximately 2550 psi and approximately 2850 psi, approximately 2600 psi and approximately 2800 psi, approximately 2650 psi and approximately 2750 psi. In certain embodiments, the pressure is at or approximately 1071 psi to at or approximately 4950 psi, and optionally 1500 psi. The ranges specified in this paragraph are inclusive of each stated end point and all 1 psi increments encompassed thereby. In certain embodiments, the pressure rating of the supercritical vessel can determine the maximum pressure that can be utilized.

Additionally, the temperature within the vessel chamber 7 can be adjusted to between approximately −145° C. to approximately 130° C., approximately −140° C. to approximately 125° C., approximately −135° C. to approximately 120° C., approximately −130° C. to approximately 115° C., approximately −125° C. to approximately 110° C., approximately −120° C. to approximately 105° C., approximately −115° C. to approximately 100° C., approximately −110° C. to approximately 95° C., approximately −105° C. to approximately 90° C., approximately −100° C. to approximately 85° C., approximately −95° C. to approximately 80° C., approximately −90° C. to approximately 75° C., approximately −85° C. to approximately 70° C., approximately −80° C. to approximately 65° C., approximately −75° C. to approximately 60° C., approximately −70° C. to approximately 55° C., approximately −65° C. to approximately 50° C., approximately −60° C. to approximately 45° C., approximately −55° C. to approximately 40° C., approximately −50° C. to approximately 35° C., approximately −45° C. to approximately 30° C., approximately −40° C. to approximately 25° C., approximately −35° C. to approximately 20° C., approximately −30° C. to approximately 15° C., approximately −25° C. to approximately 10° C., approximately −20° C. to approximately 5° C., approximately −15° C. to approximately 0° C., approximately −10° C. to approximately −5° C., approximately −5° C. to approximately 0° C., approximately 0° C. to approximately 5° C., approximately 5° C. to approximately 10° C., approximately 10° C. to approximately 15° C., approximately 15° C. to approximately 20° C., approximately 20° C. to approximately 25° C., approximately 25° C. to approximately 30° C., approximately 30° C. to approximately 35° C., or approximately 35° C. to approximately 40° C. In certain embodiments, the temperature is varied between at or approximately 35° C. to at or approximately 125° C. The ranges specified in this paragraph are inclusive of each stated end point and all 1° C. increments encompassed thereby.

In certain embodiments, the pressure is at or approximately 800 psi to at or approximately 4000 psi, and/or the temperature is at or approximately 30° C. to at or approximately 375° C.

The desired pressure and temperature within the vessel chamber 7 to achieve supercritical conditions can vary based on the composition of particular fluid employed (e.g., taking into account the supercritical point for that etchant). For example, where the fluid is CO₂, the pressure can be at or approximately 1071 psi and the temperature can be at or approximately 31° C. Where the fluid is N₂, the pressure can be at or approximately 493 psi and the temperature can be at or approximately −147° C. Where the fluid is H₂O, the pressure can be at or approximately 3203 psi and the temperature can be at or approximately 374° C. Where the fluid is methanol, the pressure can be at or approximately 1160 psi and the temperature can be at or approximately 239° C. Where the fluid is ethanol, the pressure can be at or approximately 890 psi and the temperature can be at or approximately 466° C. Where the fluid is ammonia, the pressure can be at or approximately 1640 psi and the temperature can be at or approximately 132.4° C.

The etching duration may vary from approximately 1 hour to approximately 24 hours (or more), with specific conditions optimized for efficient conversion. In certain embodiments, the etching step is performed for a duration of at or approximately 1 hour, at or approximately 2 hours, at or approximately 3 hours, at or approximately 4 hours, at or approximately 5 hours, at or approximately 6 hours, at or approximately 7 hours, at or approximately 8 hours, at or approximately 9 hours, at or approximately 10 hours, at or approximately 11 hours, at or approximately 12 hours, at or approximately 13 hours, at or approximately 14 hours, at or approximately 15 hours, at or approximately 16 hours, at or approximately 17 hours, at or approximately 18 hours, at or approximately 19 hours, at or approximately 20 hours, at or approximately 21 hours, at or approximately 22 hours, at or approximately 23 hours, at or approximately 24 hours, at or approximately 25 hours, at or approximately 26 hours, at or approximately 27 hours, at or approximately 28 hours, at or approximately 29 hours, or at or approximately 30 hours. In certain embodiments, the methods hereof allow for etching to occur within at or approximately 2 to at or approximately 8 hours (such as at or approximately 2.5-7.5 hours, at or approximately 3-7 hours, at or approximately 3.5-6.5 hours, at or approximately 4-6 hours, at or approximately 4.5-5.5 hours, or at or approximately 5 hours). All stated ranges in this paragraph are inclusive of the stated end points and all 10-minute increments encompassed thereby.

By way of non-limiting example, where TMAF tetrahydrate is utilized as a halogenating agent in the liquid medium, during the etching process, TMAF cations and fluoride anions can form when dissolved in the extraneous water that is present upon the melting of TMAF·4H₂O (solvated form of TMAF). The fluoride anions can then selectively etch (i.e., react with) the interstitial A-layer atoms (aluminum in the case of Ti3AlC2). AlF3 can thus be formed as the aluminum is etched, and can be washed away during subsequent processing steps. What remains is the multilayered Ti3C2Tx MXene, where x represents surface termination groups (e.g., —F, —O, —OH, etc.). In certain embodiments where TMAF is the halogenating agent, the etching duration is 5 hours.

In certain embodiments of the present methods, HF is not produced in situ during etching.

Upon completion of the etching process, the interior of the supercritical vessel can be vented to ambient pressure. This can be achieved by opening one or more pressure relief valves or outlets on the supercritical vessel 200 or as is otherwise conventionally known.

The MXenes can also be washed one or more times to remove residual reactants. The washing process can involve the use of water and centrifugation, for example.

The methods hereof can optionally comprise the conversion of multilayered MXenes to a delaminated form. This conversion can be achieved through techniques such as ultrasonic probe, mechanical agitation, or intercalation, with lithium chloride (LiCl) being a potential intercalating agent. In certain embodiments, delamination of the MXenes is executed through one or more of sonication, high shear mixing, homogenization, chemical intercalation, manual shaking, planetary mixing, or milling. In certain embodiments, delamination of the MXenes is executed using a Taylor Vortex Flow Reactor. In certain embodiments, delamination of the MXenes is executed using high-pressure homogenization (HPH) as described in International Patent Application Publication No. WO2024/263892. For example, an HPH instrument can be utilized to achieve delamination and reduction in flake size.

The method described provides a safer and more efficient alternative to conventional etching techniques by eliminating the production of HF during the etching process. The resulting MXene compositions, such as Ti₃C₂Tₓ, are suitable for applications in battery technologies and coating formulations, as well as electromagnetic interference (EMI) shielding and water filtration applications.

The process is adaptable to various MAX phase materials and can accommodate different batch sizes, ranging from small-scale to larger-scale production. In certain embodiments, the methods hereof can be used with batch sizes of at or between approximately 1-10 grams. In certain embodiments, the methods hereof can be used with batch sizes of at or about 50 grams. In certain embodiments, the methods hereof can be used with batch sizes of at or approximately 0.5 kg. In certain embodiments, the methods hereof can be used with batch sizes of more than 0.5 kg.

The Ti3C2Tx MXene composition resulting from the methods described herein include particle sizes (lateral flake dimensions) that range from less than 1 micron to 20 microns. The Ti3C2Tx MXene product resulting from the methods described herein include a thicknesses of approximately 1 nanometer for single-layer MXene to hundreds of nanometers (or several microns) for multilayered MXene particles. These flake dimensions are consistent with those obtained from the traditional MXene fabrication techniques, including the HF/HCl mixed-acid method.

### General

Those skilled in the art will recognize that numerous modifications can be made to the specific implementations described above. The implementations should not be limited to the particular embodiments described. Other implementations may be possible.

While the methods are illustrated and described in detail in the foregoing description, the same is to be considered as illustrative and not restrictive in character, it being understood that only certain embodiments have been shown and described and that all changes and modifications that come within the spirit of the invention are desired to be protected.

It is intended that that the scope of the present compositions and methods are defined by the following claims. However, this disclosure can be practiced otherwise than is specifically explained and illustrated without departing from its spirit or scope. Those skilled in the art will understand that various alternatives to the embodiments described herein can be employed in practicing the claims without departing from the spirit and scope as defined in the following claims.

All publications, patents, patent application publications, journal articles, textbooks, and other publications referred to in this document are indicative of the level of skill of those in the art to which the disclosure pertains. All such publications are incorporated herein by reference to the same extent as if each individual publication were specifically and individually indicated to be incorporated by reference. In the event of inconsistent usages between this document and those documents so incorporated by reference, the usage in the incorporated reference should be considered supplementary to that of this document; for irreconcilable inconsistencies, the usage in this document controls.

The terms and expressions employed are used as terms of description and not of limitation. Where certain terms are defined and are otherwise described or discussed elsewhere in the “Detailed Description,” all such definitions, descriptions, and discussions are intended to be attributed to such terms. There also is no intention in the use of such terms and expressions of excluding any equivalents of the features shown and described or portions thereof. Furthermore, while subheadings may be used in the “Detailed Description,” such use is solely for ease of reference and is not intended to limit any disclosure made in one section to that section only; rather, any disclosure made under one subheading is intended to constitute a disclosure under each and every other subheading.

### Certain Definitions

As used herein, the following terms and phrases shall have the meanings set forth below. Unless defined otherwise, all technical and scientific terms used herein have the same meaning as commonly understood to one of ordinary skill in the art.

The term “about” or “approximately” means within an acceptable range for the particular value as determined by one of ordinary skill in the art, which will depend in part on how the value is measured or determined, e.g., the limitations of the measurement system. For example, “about” can mean a range of up to 20%, preferably up to 10%, more preferably up to 5%, and more preferably still up to 1% of a given value. By way of further example, “about” or “approximately” can mean within 90%, within 95%, 99%, 99.5%, 99.9%, 99.99%, or at least about 99.999% or more of a stated value or of a stated limit of a range. Alternatively, particularly with respect to biological systems or processes, the term can mean within an order of magnitude, preferably within 5-fold, and more preferably within 2-fold, of a value. Unless otherwise stated, the term “about” means within an acceptable error range for the particular value, such as ±1-20%, preferably ±1-10% and more preferably ±1-5%.

Where a range of values is provided, it is understood that each intervening value, between the upper and lower limit of that range and any other stated or intervening value in that stated range, is encompassed. The upper and lower limits of these smaller ranges can independently be included in the smaller ranges, and are also encompassed, subject to any specifically excluded limit in the stated range. Where the stated range includes one or both limits, ranges excluding either or both of those limits are also included.

A phrase referring to “one or more” or “at least one of” a list of items refers to any combination of those items, including single members. As an example, “at least one of a, b, or c” is intended to cover: a, b, c, a-b, a-c, b-c, and a-b-c.

The terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation.

### EXAMPLES

The following examples serve to illustrate the present disclosure. The examples are not intended to limit the scope of the claimed methods in any way.

### Example 1

### Synthesis of MXene

MXenes were synthesized using a method described herein. Initially, approximately 13 grams of ammonium fluoride (NH₄F) was dissolved in approximately 40 milliliters of water and subjected to magnetic stirring at approximately 300 revolutions per minute (rpm). In a separate preparation, 29.2 grams of a solvated form of tetramethylammonium fluoride tetrahydrate (TMAF·4H₂O) was measured. Each solution/mass (i.e., the liquid medium or precursor thereto, noting the TMAF·4H₂O melted around 40° C.) was subsequently transferred into separate supercritical vessels.

Approximately 5 grams of MAX Phase Ti₃AlC₂ was introduced into each vessel. The head of each supercritical vessel was then closed and sealed to prevent leakage, and liquid carbon dioxide (CO₂) was introduced into each vessel using a high-pressure pump, while stirring was performed to mix within the vessel. Upon the introduction of the liquid CO₂, a pressure of approximately 700-800 psi was observed, as monitored by the pressure gauge.

The vessel temperatures were then elevated to a predetermined temperature using a heating mantle and heating jacket to ensure the CO₂ transitioned to a supercritical state. It is noted that the critical point for CO₂ is 131° C. and approximately 1100 psi, which were the conditions necessary for achieving the supercritical state.

After a duration of 5 hours, the closed vessels were vented to ambient pressure. The outlet of each vessel was equipped with a fritted metal outlet featuring 2-5 micron pore sizes, which ensured retention of the solid MXene product within the vessel while allowing for the escape of CO₂ and other gases.

Once ambient temperature and pressure were attained, the vessels were opened, and the contents were subsequently washed several times with water, utilizing centrifugation to remove any residual impurities.

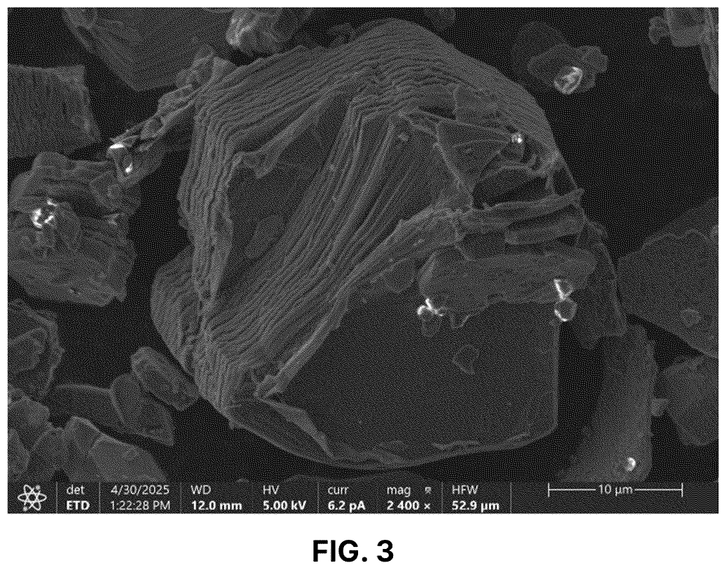

FIG. 3 illustrates an image of the multilayered MXene product resulting from the TMAF·4H₂O test group.

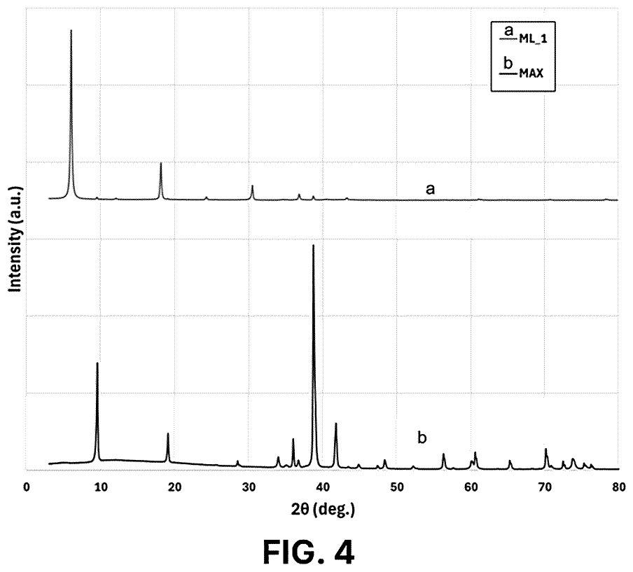

FIG. 4 provides a comparison of the X-ray diffraction spectrum for Ti₃AlC₂ MAX phase (pre-supercritical CO₂ processing) and Ti₃C₂Tx (post-supercritical CO₂ processing) of the NH₄F test group. The characteristic MAX phase peak at 2θ=˜39°, corresponding to the (014) crystallographic plane, was significantly reduced in the supercritically etched multilayered sample, indicating the removal of aluminum. Additionally, the characteristic MAX peak commonly observed at 2θ=˜9.5°, corresponding to the (002) plane (i.e., the spacing between the Ti₃C₂ layers), was shifted to 2θ=˜7° in the supercritically etched multilayered sample, indicating aluminum removal and an expansion in spacing between the Ti₃C₂Tx layers.

The multilayered MXenes were then converted to the delaminated form of Ti₃C₂Tx using traditional methods, including ultrasonic probe, mechanical agitation, or intercalation (e.g., LiCl).

### Example 2

### Etching Duration

Etching durations of the methods were also studied. The protocol of Example 1 was performed, utilizing NH₄F as the halogenating agent and water as the solvent. Various concentrations of NH₄F in water were tested, consistently resulting in a neutral pH, which may contribute to the stability of the etching process.

The NH₄F/water liquid medium was employed in conjunction with supercritical CO₂ within a supercritical vessel to etch a Ti₃AlC₂ MAX phase. In contrast to the 24-hour etching duration typically performed in conventional hydrofluoric acid (HF)/hydrochloric acid (HCl) methods, the present method demonstrated a reduction in MXene conversion time to a range of 2-8 hours across each test group. This reduction in etching duration could be attributed to the enhanced reactivity and penetration capabilities of the supercritical CO₂, which facilitates more efficient interaction with the Ti₃AlC₂ MAX phase.

### Enumerated Embodiments

Clause 1: A method for synthesizing two-dimensional MXenes, the method comprising: preparing a liquid medium comprising a MAX phase material and one or more halogenating agents; sealing the liquid medium within an interior of a supercritical vessel, wherein the vessel is configured to withstand elevated pressures and temperatures for achieving supercritical conditions within the interior; and etching the MAX phase material within the liquid medium to convert the MAX phase material to MXenes by introducing a fluid into an interior of the sealed vessel and adjusting the interior conditions of the supercritical vessel to convert the fluid to a supercritical state.

Clause 2: The method of Clause 1, wherein preparing a liquid medium comprises: combining the MAX phase material and the one or more halogenating agents and melting the one or more halogenating agents; or dissolving the one or more halogenating agents in a solvent to form a liquid medium and adding or introducing the MAX phase material into the liquid medium.

Clause 3: The method of Clause 1, further comprising venting the vessel to adjust the internal pressure within the supercritical vessel to match ambient atmospheric pressure.

Clause 4: The method of Clause 1, further comprising washing the MXenes to remove residual reactants.

Clause 5: The method of Clause 1, wherein the one or more halogenating agents comprises a fluorinating agent.

Clause 6: The method of Clause 1, wherein the one or more halogenating agents comprise one or more halogen salts, each independently containing fluorine (F), chlorine (Cl), bromine (Br), iodine (I), astatine (At), or tennessine (Ts) and, optionally are hydrated salts.

Clause 7: The method of any of the foregoing Clauses, wherein the interior conditions of the sealed vessel comprise temperature and pressure.

Clause 8: The method of any of the foregoing Clauses, wherein the one or more halogenating agents comprise tetramethylammonium fluoride tetrahydrate (TMAF·4H2O), ammonium fluoride (NH₄F), potassium fluoride (KF), and/or derivatives of any of the foregoing.

Clause 9: The method of any of the foregoing Clauses, with the proviso that the halogenating agents and, in particular, the fluorinating agent is not hydrofluoric acid (HF).

Clause 10: The method of any of the foregoing Clauses, wherein the one or more halogenating agents are dissolved in water.

Clause 11: The method of any of the foregoing Clauses, wherein the MAX phase material is a layered ternary carbide or nitride characterized by the general formula Mₙ₊₁AXₙ, wherein: M is a transition metal, A is an A-group element, and X is carbon (C) and/or nitrogen (N).

Clause 12: The method of any of the foregoing Clauses, wherein the MAX phase material is or comprises Ti₃AlC₂, Ti₃SiC₂, Ti₂AlC, or Cr₂AlC.

Clause 13: The method of any of the foregoing Clauses, wherein the fluid is or comprises carbon dioxide (CO₂), water (H₂O), or nitrogen (N₂).

Clause 14: The method of Clause 3, wherein the pressure is at or approximately 800 psi to at or approximately 4000 psi and/or the temperature is at or approximately 30° C. to at or approximately 375° C.

Clause 15: The method of Clause 3, wherein the pressure ranges from approximately 1071 psi to approximately 4000 psi (such as, for example, 3203 psi), and is optionally at or approximately 1500 psi.

Clause 16: The method of Clause 3, wherein: the fluid is CO₂, the pressure is at or about 1071 psi and the temperature is at or about 31° C.; or the fluid is N₂, the pressure is at or about 493 psi and the temperature is at or about −147° C.; or the fluid is water (H₂O), the pressure is at or about 3203 psi and the temperature is at or about 374° C.

Clause 17: The method of any of the foregoing Clauses, wherein the etching step is performed for a duration ranging from approximately 1 hour to approximately 24 hours.

Clause 18: The method of any of the foregoing Clauses, wherein the etching step is performed for a duration of approximately 5 hours.

Clause 19: The method of any of the foregoing Clauses, wherein the liquid medium comprises a polar solvent.

Clause 20: The method of Clause 19, wherein the polar solvent is a polar aprotic solvent.

Clause 21: The method of Clause 19, wherein the polar solvent comprises at least one of water, methanol, or ethanol.

Clause 22: The method of Clause 20, wherein the polar aprotic solvent comprises at least one of acetone, dimethylformamide (DMF), acetonitrile, dimethyl sulfoxide, or propylene carbonate.

Clause 23: The method of any of the foregoing Clauses, further comprising delaminating the MXenes.

Clause 24: The method of Clause 23, wherein delaminating the MXenes is executed through one or more of sonication, high shear mixing, homogenization, chemical intercalation, manual shaking, planetary mixing, and/or milling.

Clause 25: The method of Clause 23 or Clause 24, wherein delaminating the MXenes is executed using a Taylor Vortex Flow Reactor.

Clause 26: The method of any of the foregoing Clauses, wherein the supercritical vessel comprises a nickel-molybdenum alloy which optionally is a Hastelloy alloy.

Clause 27: The method of Clause 26, wherein the nickel-molybdenum alloy is selected from the group consisting of Hastelloy C and Hastelloy B and is optionally Hastelloy C-276.

Clause 28: The method of any of the foregoing Clauses, wherein the supercritical vessel comprises a nickel-based alloy, the alloy comprising nickel, chromium, molybdenum, iron, carbon, silicon, and optionally tungsten.

Clause 29: A method for synthesizing MXenes, the method comprising: combining a MAX phase material and one or more halogenating agents and melting the one or more halogenating agents to form a liquid medium, or dissolving one or more halogenating agents in a solvent and adding a MAX phase material thereto to form a liquid medium; sealing the liquid medium within an interior of a supercritical vessel, wherein the vessel is configured to withstand elevated pressures and temperatures for achieving supercritical conditions within the interior; introducing fluid into, and adjusting a temperature and pressure within, the interior of the vessel to convert the fluid to a supercritical state, etch the MAX phase material in the liquid medium, and convert the MAX phase material into MXenes; venting the interior of the supercritical vessel to ambient pressure; and washing the MXenes to remove residual reactants.

Clause 30: The method according to Clause 1 or Clause 29, wherein the one or more halogenating agents is ammonium fluoride (NH₄F) and dissolving one or more halogenating agents in a solvent is performed with approximately 12 g of NH₄F in about 20 mL of water; or the one or more halogenating agents is tetramethylammonium fluoride tetrahydrate (TMAF·4H2O) and approximately 29.2 g of TMAF·4H2O is combined with the MAX phase material and melted.

Clause 31: The method according any of the foregoing Clauses, wherein the supercritical vessel is equipped with a rupture disc, a thermocouple, an inlet valve, an outlet valve, a pressure gauge, and an overhead stirrer.

Clause 32: The method according to any of the foregoing Clauses, wherein the pressure within the vessel is adjustable within a range extending from ambient atmospheric pressure up to at least approximately 5000 psi.

Clause 33: The method according to any of the foregoing Clauses, wherein the temperature within the vessel is adjustable within a range extending from ambient temperature to approximately 131° C.

Clause 34: The method according to Clause 29, wherein the etching time ranges from approximately 1 hour to approximately 24 hours.

Clause 35: The method according to Clause 29, further comprising converting multilayered MXenes to a delaminated form using ultrasonic probe, mechanical agitation, or intercalation.

Clause 36: The method according to Clause 35, wherein the intercalation is performed using lithium chloride (LiCl).

Clause 37: The method according to any of the foregoing Clauses, wherein hydrofluoric acid (HF) is not produced during etching and/or with the proviso that the fluorinating agent is not HF.

Clause 38: The method according to any of the foregoing Clauses, resulting in a MXene batch size of at or between approximately 1-10 grams, at or approximately 50 grams, at or approximately 0.5 kg, or more than approximately 0.5 kg.

1. A method for synthesizing two-dimensional MXenes comprising:
preparing a liquid medium comprising a MAX phase material and one or more halogenating agents;
sealing the liquid medium within an interior of a supercritical vessel, wherein the vessel is configured to withstand elevated pressures and temperatures necessary for achieving supercritical conditions within the interior; and
etching the MAX phase material within the liquid medium to convert the MAX phase material to MXenes by introducing a fluid into an interior of the sealed vessel and adjusting the interior conditions of the supercritical vessel to convert the fluid to a supercritical state.

2. The method of claim 1, wherein preparing a liquid medium comprises:
combining the MAX phase material and the one or more halogenating agents and melting the one or more halogenating agents; or
dissolving the one or more halogenating agents in a solvent to form a liquid medium, and adding the MAX phase material to the liquid medium.

3. The method of claim 1, further comprising venting the vessel to adjust the internal pressure within the supercritical vessel to match ambient atmospheric pressure.

4. The method of claim 1, further comprising washing the MXenes to remove residual reactants.

5. The method of claim 1, wherein the one or more halogenating agents comprises a fluorinating agent.

6. The method of claim 1, wherein the one or more halogenating agents comprise one or more halogen salts, each independently containing fluorine (F), chlorine (Cl), bromine (Br), iodine (I), astatine (At), or tennessine (Ts) and, optionally, are hydrated salts.

7. The method of claim 1, wherein the interior conditions of the sealed vessel comprise temperature and pressure.

8. The method of claim 1, wherein the one or more halogenating agents comprise tetramethylammonium fluoride tetrahydrate (TMAF·4H2O), ammonium fluoride (NH₄F), potassium fluoride (KF), and/or derivatives of any of the foregoing.

9. The method of claim 5, with the proviso that the fluorinating agent is not hydrofluoric acid (HF).

10. The method of any one of claims 1-5, wherein the one or more halogenating agents are dissolved in water.

11. The method of any one of claims 1-5, wherein the MAX phase material is a layered ternary carbide or nitride characterized by the general formula Mₙ₊₁AXₙ, wherein:
M is a transition metal,
A is an A-group element, and
X is carbon (C) and/or nitrogen (N).

12. The method of any one of claims 1-5, wherein the MAX phase material is or comprises Ti₃AlC₂, Ti₃SiC₂, Ti₂AlC, or Cr₂AlC.

13. The method of any one of claims 1-5, wherein the fluid is or comprises carbon dioxide (CO₂), nitrogen (N₂), or water (H2O).

14. The method of claim 3, wherein the pressure is at or approximately 800 psi to at or approximately 4000 psi and/or the temperature is at or approximately 30° C. to at or approximately 375° C.

15. The method of claim 3, wherein the pressure ranges from approximately 1071 psi to approximately 4000 psi, and is optionally at or approximately 1500 psi.

16. The method of claim 3, wherein:
the fluid is CO₂, the pressure is at or approximately 1071 psi and the temperature is at or approximately 31° C.;
the fluid is N₂, the pressure is at or approximately 493 psi and the temperature is at or approximately −147° C.; or
the fluid is H20, the pressure is at or approximately 3203 psi and the temperature is at or approximately 374° C.

17. The method of claim 1, wherein the etching step is performed for a duration ranging from approximately 1 hour to approximately 24 hours.

18. The method of claim 12, wherein the etching step is performed for a duration of approximately 5 hours.

19. The method of claim 1, wherein the liquid medium comprises a polar solvent.

20. The method of claim 19, wherein the polar solvent is a polar aprotic solvent.

21. The method of claim 19, wherein the polar solvent comprises at least one of water, methanol, or ethanol.

22. The method of claim 20, wherein the polar aprotic solvent comprises at least one of acetone, dimethylformamide (DMF), acetonitrile, dimethyl sulfoxide, or propylene carbonate.

23. The method of claim 1, further comprising delaminating the MXenes.

24. The method of claim 23, wherein delaminating is executed through one or more of sonication, high shear mixing, homogenization, chemical intercalation, manual shaking, planetary mixing, or milling.

25. The method of claim 23, wherein delaminating is executed using a Taylor Vortex Flow Reactor.

26. The method of claim 1, wherein the supercritical vessel comprises a nickel-molybdenum alloy which is optionally a Hastelloy alloy.

27. The method of claim 26, wherein the nickel-molybdenum alloy is selected from the group consisting of Hastelloy C and Hastelloy B and is optionally Hastelloy C-276.

28. The method of claim 1, wherein the supercritical vessel comprises a nickel-based alloy, the alloy comprising nickel, chromium, molybdenum, iron, carbon, silicon, and optionally tungsten.

29. A method for synthesizing MXenes, the method comprising:
combining MAX phase material and one or more halogenating agents and melting the one or more halogenating agents to form a liquid medium, or dissolving the one or more halogenating agents in a solvent and adding a MAX phase material to form a liquid medium;
sealing the liquid medium within an interior of a supercritical vessel, wherein the vessel is configured to withstand elevated pressures and temperatures necessary for achieving supercritical conditions within the interior;
introducing fluid into, and adjusting a temperature and pressure within, the interior of the vessel to convert the fluid to a supercritical state, etch the MAX phase material in the liquid medium, and convert the MAX phase material into MXenes;
venting the interior of the supercritical vessel to ambient pressure; and
washing the MXenes to remove residual reactants.

30. The method according to claim 1 or claim 29, wherein:
the one or more halogenating agents is ammonium fluoride (NH₄F) and dissolving one or more halogenating agents in a solvent is performed with approximately 13 g of NH₄F in about 40 mL of water; or
the one or more halogenating agents is tetramethylammonium fluoride tetrahydrate (TMAF 4H2O) and approximately 29.2 g of TMAF·4H2O is combined with the MAX phase material and melted.

31. The method according to claim 1 or 29, wherein the supercritical vessel is equipped with a rupture disc, a thermocouple, an inlet valve, an outlet valve, a pressure gauge, and an overhead stirrer.

32. The method according to claim 1 or claim 29, wherein the pressure within the vessel is adjustable within a range extending from ambient atmospheric pressure up to at least approximately 5000 psi.

33. The method according to claim 1 or claim 29, wherein the temperature within the vessel is adjustable within a range extending from ambient temperature to approximately 131° C.

34. The method according to claim 29, wherein the etching time ranges from approximately 1 hour to approximately 24 hours.

35. The method according to claim 29, further comprising converting multilayered MXenes to a delaminated form using ultrasonic probe, mechanical agitation, or intercalation.

36. The method according to claim 35, wherein the intercalation is performed using lithium chloride (LiCl).

37. The method according to claim 29, wherein hydrofluoric acid (HF) is not produced during etching.

38. The method according to claim 1 or claim 29, resulting in a MXene batch size of at or between approximately 1-10 grams, at or approximately 50 grams, at or approximately 0.5 kg, or more than approximately 0.5 kg.
